(19) United States
(12) Patent Application Publication
(10) Pub. No.: US 2006/0198121 A1
(43) Pub. Date: Sep. 7, 2006

(54) Shoe with animated electro-luminescent display

(76) Inventors: David Thorpe, Acton, MA (US); Robert W. Gardner, Hampton, NH (US)

Correspondence Address: FISH & RICHARDSON PC, P.O. BOX 1022, MINNEAPOLIS, MN, 55440-1022, US

(21) Appl. No.: 11/371,203

(22) Filed: Mar. 7, 2006

Related U.S. Application Data
(60) Provisional application No. 60/659,208, filed on Mar. 7, 2005.

(51) Int. Cl. F21V 21/08

(52) U.S. Cl. 362/103; 362/84

(57) ABSTRACT

A shoe having an electro-luminescent display with individually addressable portions.

### RELATED APPLICATIONS

This application claims priority under 35 U.S.C. §119 from U.S. Provisional Patent Application No. 60/659,208 filed Mar. 7, 2005, the contents of which are incorporated herein by reference.

### TECHNICAL FIELD

This disclosure relates to shoes, and in particular, to shoes with lights.

### BACKGROUND

A familiar sight for many years has been that of children running and playing accompanied by the flashing of lights attached to their shoes. Such lights serve as attractive visual ornaments. By enhancing the wearer's visibility, these lights also serve as safety devices. Exemplary lighted shoes include those in which signals from a motion-sensing switch trigger light-emitting diodes to flash.

Known lights for such shoes include light-emitting diodes (LED's). LED's provide point sources of illumination. These LED's are often controlled by controllers that, in response to a motion-sensitive switch, cause the LED's to flash according to predetermined patterns.

An alternative light source is one relying on electroluminescence.

Various types of lighted shoes, and related devices have been described in U.S. Patent Nos. 4,775,864, 5,611,621, 5,955,957, and 6,764,193.

### SUMMARY

Generally, this disclosure relates to electro-luminescent displays for shoes. The electro-luminescent displays can be mounted on a visible portion of the shoe.

In one aspect, the invention features a shoe having an electro-luminescent light emitting display having a first portion and a second portion; and a controller in electrical communication with the first and second portions of the display.

In some embodiments, the display is mounted to be visible from outside the shoe. For example, the display can be mounted on a vamp, a quarter, or a tongue.

In other embodiments, the controller is encased in a sole of the shoe.

Additional embodiments include those in which the display has a first non-conductive substrate; a second non-conductive substrate; and a patterned phosphor material sandwiched between the first and second non-conductive substrates, the phosphor material being in electrical communication with the controller.

In some embodiments, the controller is configured to send electrical power to illuminate predetermined portions of the patterned phosphor material. Exemplary sequences include predetermined sequences, and random sequences.

In other embodiments, the second non-conductive substrate includes a light-transmissive colored film. In some of these embodiments, a pattern defined by the light-transmissive film corresponds to a pattern defined by the patterned phosphor material.

In some embodiments, a thickness of the display is less than about 0.050 inches. Among these are those embodiments in which the thickness of the display is less than about 0.025 inches, and those in which the thickness is less than about 0.015 inches.

Other embodiments include those in which a thickness of the first non-conductive substrate is less than about 0.010 inches.

Among these are embodiments in which the thickness is less than about 0.005 inches. Yet other embodiments include those in which a thickness of the second non-conductive substrate is less than about 0.015 inches. Among these are embodiments in which the thickness of the second non-conductive substrate is less than about 0.010 inches.

In some embodiments, the first non-conductive substrate includes polyester.

In other embodiments, the patterned phosphor material includes an inorganic material. One example of an inorganic material includes zinc sulphide.

Embodiments of the invention also include those in which a thickness of the patterned phosphor material is less than about 0.001 inches. Among these are those embodiments in which the thickness of the patterned phosphor material is less than about 0.0005 inch.

Other embodiments include those having a motion-sensitive switch in electrical communication with the controller, and those including a master switch disposed to disable illumination of the display.

In another aspect, the invention features a shoe having a light source; a DC power source; a DC/AC inverter disposed between the light source and the DC power source; and a controller for selectively connecting and AC output to different portions of the display.

Some embodiments include those in which the light source includes an electro-luminescent display having individually addressable portions.

In another aspect, the invention features a shoe including an electro-luminescent display.

All publications, patent applications, patents, and other references mentioned herein are incorporated by reference in their entirety.

The details of one or more implementations are set forth in the accompanying drawings and the description below. Other features, and advantages of the invention will be apparent from the description and drawings, and from the claims.

### DESCRIPTION OF DRAWINGS

FIG. 1 is a side view of a shoe including an electro-luminescent light emitting display mounted to a vamp thereof.

FIG. 2 is an exploded view of the electro-luminescent light emitting display of FIG. 1, along with a controller and related wiring.

FIGS. 3 and 5 are block diagrams of the controller of FIG. 2.

FIG. 4 is a cross-section of the display shown in FIG. 2.

### DETAILED DESCRIPTION

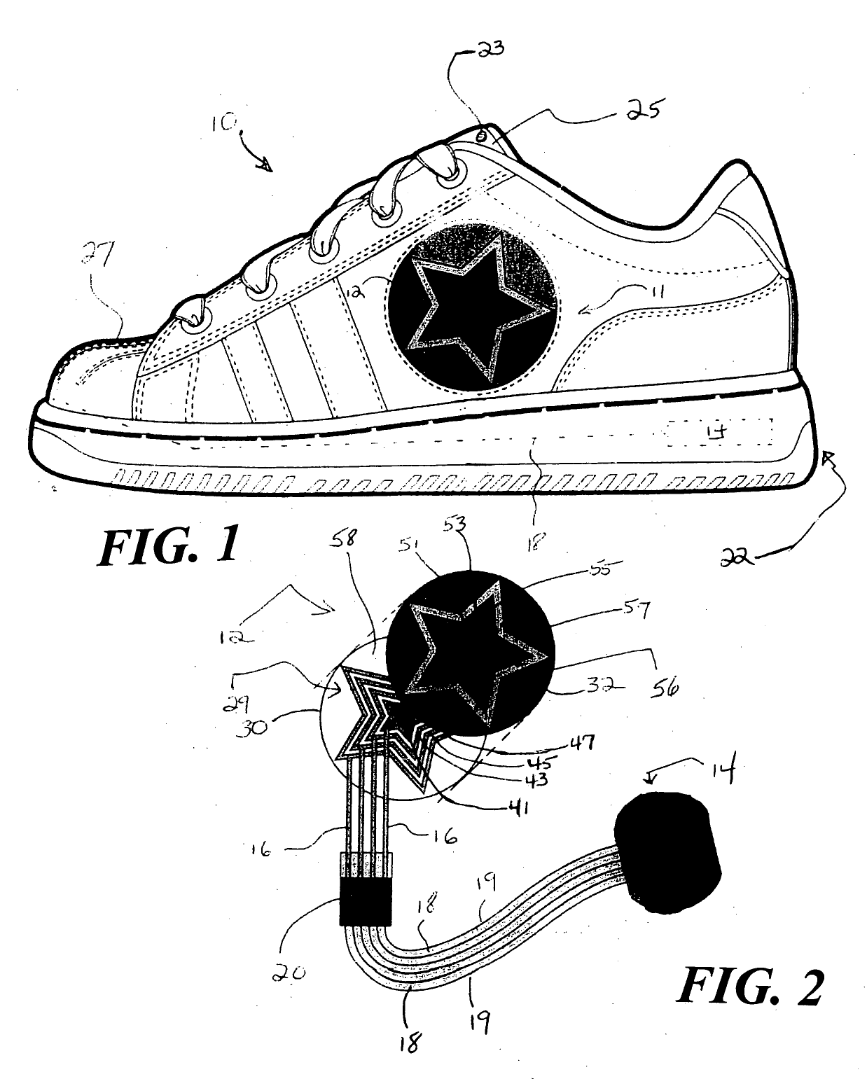

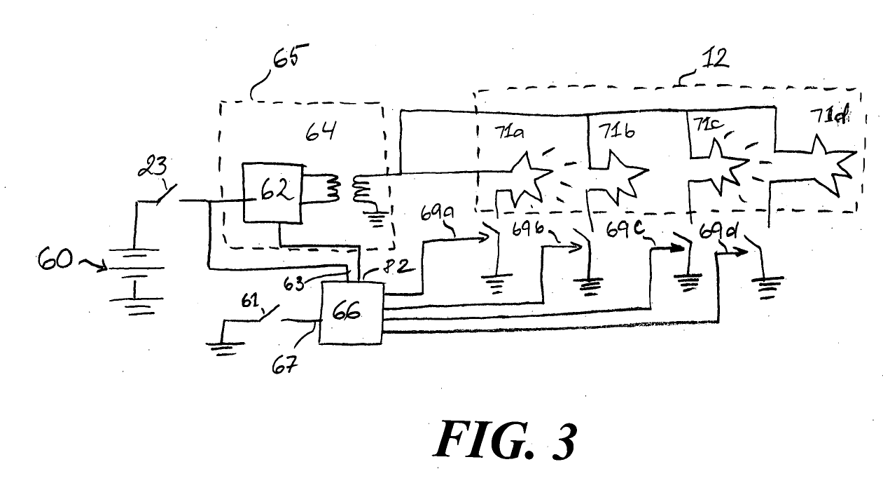

Referring to FIGS. 1 and 2, a particular embodiment of a shoe 10 includes a vamp 11 on which is mounted a generally planar, flexible electro-luminescent light emitting display 12 and a controller 14 that controls illumination of the display 12. An electrical coupler 20 connects leads 16 of the display 12 to wires 18 extending from the controller 14. These wires 18 are buried within an insulating jacket 19.

The controller 14 is mounted within a sole 22 of the shoe 10 and electrically connected, by the wires 18, to an optional master switch 23 mounted on a tongue 25 of the shoe 10. To make the connection with the master switch 23, the wires 18 are snaked behind the inner liner, through the sole 22, and then through the upper 27 and the tongue 25. A master switch 23 is particularly useful for disabling the display 12 when the shoe 10 is worn in circumstances in which an illuminated display 12 might be inappropriate, for example, in a movie theatre or in a place of religious worship.

The controller 14 is configured to intermittently direct electrical power to selected portions of a phosphor material 29. This causes selective illumination of different portions of the phosphor material 29 at different times, resulting an eye-catching animation effect.

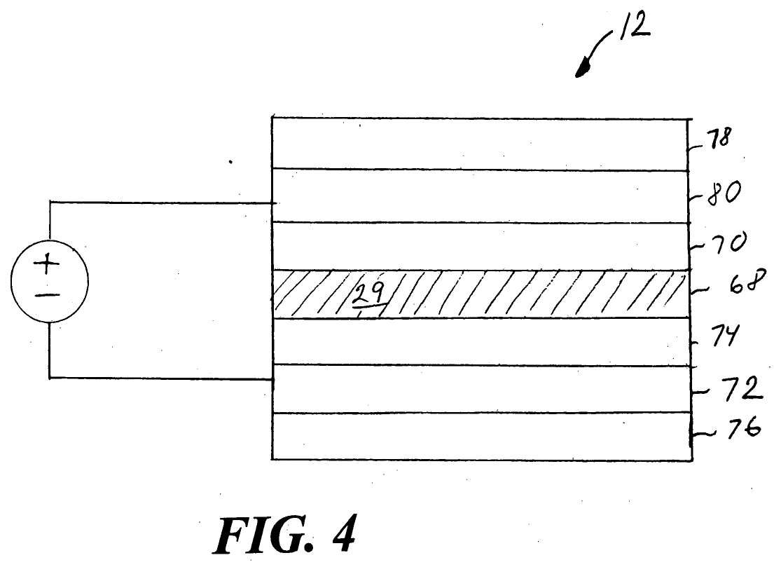

Referring to FIG. 3, a typical controller 14 includes an energy source 60 in communication with power-conditioning circuitry 65 and with a function interface 66. The master switch 23 selectively disconnects the energy source 60 from the power-conditioning circuitry 65 and from the function interface 66.

A suitable energy source 60 is a DC source, such as a battery. Exemplary batteries suitable for use in a shoe 10 include silver oxide “button cell” batteries, AA batteries, and AAA batteries.

The power-conditioning circuitry 65 includes a DC-to-AC inverter 62 for transforming a DC voltage provided by the energy source 60 into an input AC voltage presented to the input terminals of a step-up transformer 64. The step-up transformer 64 then increases the input AC voltage to an output AC voltage having an amplitude sufficient to drive the display 12.

The function interface 66 includes circuitry for actuating display switches 69a, 69b, 69c, 69d that selectively connect and disconnect individually addressable portions 71a, 71b, 71c, 71d of the display 12 from the transformer 64. The function interface 66 includes a power supply input 63 and a ground connection 67.

The ground connection 67 is connected to a motion-sensitive switch 61 that selectively connects and disconnects the function interface 66 from the energy source 60.

The function interface 66 is typically implemented as a logic circuit or as a microprocessor or microcontroller based circuit having outputs for controlling the display switches 69a, 69b, 69c, 69d. In some embodiments, the function interface 66 has an output connected to the inverter 62. This enables the function interface 66 to turn the inverter 62 on only when it is needed.

A suitable motion-sensitive switch 61 is a spring-loaded switch having a spring constant chosen to actuate the switch 61 in response to an external force, the magnitude of which is comparable to that generated while walking. A suitable motion-sensitive switch 61 is one that is in a first state when the shoe 10 is stationary, and that changes state momentarily in response to an external force.

Another suitable motion-sensitive switch 61 is that disclosed in Rodgers, U.S. Pat. No. 4,848,009, the contents of which are herein incorporated by reference.

The motion-sensitive switch 61 has a preferred direction, the orientation of which governs the threshold force for actuating the switch 61. In particular, when the angle between the preferred direction and the force of gravity is small, the threshold force is low. When the angle is large, the threshold force is large. This feature avoids unnecessarily draining the energy source 60 during shipment by the simple expedient of transporting the shoe 10 upside-down to minimize the likelihood of actuating the motion-sensitive switch 61 in transit.

The function interface 66 enables electrical power to be sent to the display 12 at different times. This results in generation of an eye-catching animation effect in which portions 71a, 71b, 71c, 71d of the display light up according to a variety of spatial and tempered patterns. For example, the electrical power delivered to the display 12 can be in the form of pulses, separated by fixed or random intervals. Such pulses enable the display 12 to operate in “flashing” mode. Electrical power can also be delivered in such a way that the display 12, or a portion thereof, remains “permanently on” or continuously illuminated.

Referring back to FIG. 2, the display 12 includes a first insulating conductive substrate 30, a second insulating substrate 32, and a patterned phosphor material 29 sandwiched between the first and second insulating substrates 30, 32.

The phosphor material 29 is typically patterned in traces 41, 43, 45, 47, the shapes of which are selected to form an ornamental design. In the illustrated embodiments, these traces 41, 43, 45, 47, which correspond to the portions 71a, 71b, 71c, 71d shown in FIG. 3, form a nested sequence of stars. Each trace 41, 43, 45, 47 of the phosphor material 29 is in electrical communication with a lead 16 that is ultimately in electrical communication with the controller 14. The controller 14 is configured to direct power independently to each trace 41, 43, 45, 47 of the patterned phosphor material 29.

The second non-conductive substrate 32 is a patterned colored plastic film having light-transmissive windows 51, 53, 55, 57. These windows can be translucent, transparent or configured to pass light having selected wavelengths. In the case of translucent windows 51, 53, 55, 57, the degree of translucency is adjusted to hide the phosphor material 24 until it is activated.

The windows 51, 53, 55, 57 line up with corresponding traces 41, 43, 45, 47. In addition, an opaque portion 56 of the second insulating substrate 32 lines up with an inactive portion 58 of the first insulating substrate 30. In this configuration, when the controller 14 directs power to the patterned phosphor material 29, the resulting illumination is visible through the second insulating substrate 32.

In some implementations, the predetermined portions of the patterned phosphor material 29 are illuminated in a predetermined sequence. For example, the traces 41, 43, 45, 47 can be illuminated sequentially, each for a predetermined time, e.g., each for 100 milliseconds, or for a random time. This process can be repeated in a continuous loop for as long as desired. The illuminated traces 41, 43, 45, 47 are visible through corresponding windows 51, 53, 55, 57, producing a multi-colored light show that emanates outwardly from the innermost window 51.

In an exemplary implementation, star-shaped windows 51, 53, 55, 57 transmit only red, blue, green and yellow lights, respectively. The traces 41, 43, 45, 47 are formed from a white phosphor material 29, and are illuminated in ascending order, each for a predetermined time of about 250 milliseconds.

In some implementations, a thickness of the display 12 is less than about 0.050 inches, e.g., 0.040 inches, 0.025 inches, 0.020 inches or less, e.g., 0.015 inches; a thickness of the first insulating substrate 30 is less than about 0.010 inches, e.g., 0.008 inches, 0.005 inches, 0.003 inches or less, e.g., 0.002 inches; and a thickness of the second insulating substrate 32 is less than about 0.015 inches, e.g., 0.010 inch, 0.008 inches, 0.006 or less, e.g., 0.003 inches.

Phosphor materials 29 are available in a variety of colors, including white, blue-green, and yellow-green. In some implementations, the phosphor material 29 is laid down on a substrate by screen-printing.

In some implementations, the phosphor material 29 is an inorganic phosphor material, e.g., a zinc sulphide compound. In other implementations, the phosphor material 29 includes phosphor particles uniformly dispersed within a polymeric binder. Suitable phosphor particles have a particle size between about 2 microns to about 25 microns, e.g., 5 microns, 10 microns or 15 microns. Suitable polymeric binders include epoxy resins that exhibit low electrical losses, and that provide a good moisture barrier.

A suitable phosphor for use in a display 12 is one sold by Dupont Microcircuit Materials, Richmond, Del. under the trademark LUXPRINT®. Suitable displays 12 include those sold by 360 Glow, Shenzhen, China.

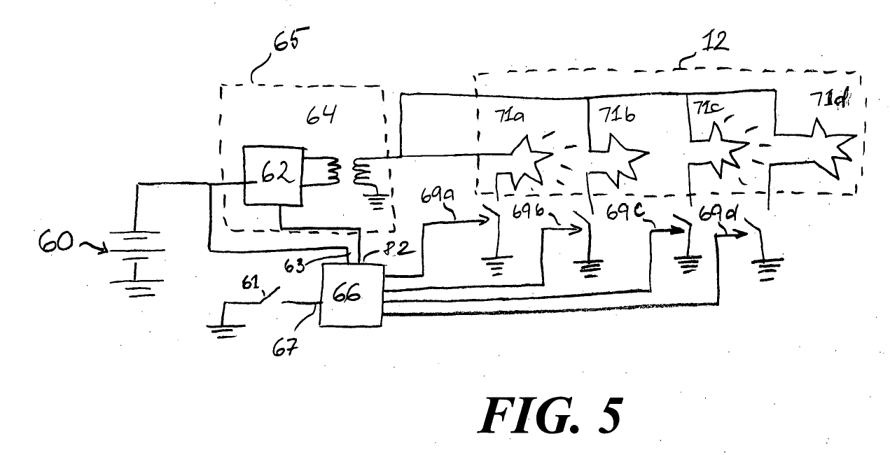

As shown in the cross-section of FIG. 4, a typical display 12 is a multilayer structure in which a phosphor layer 68 embedded with the phosphor material 29 is sandwiched between a clear ITO (indium titanium oxide) electrode layer 70 and a rear electrode layer 72. A dielectric layer 74 separates the rear electrode layer 72 from the phosphor layer 68. A suitable material for the dielectric layer 74 is barium titanate.

The remaining layers are protective or decorative in function. For example, the display includes a rear-protection film 76 to protect the rear electrode layer 72 from direct contact with the elements. A surface protection film 78 likewise protects the transparent electrode layer 70 from the elements. One material suitable for incorporation in the surface protection film 78, the rear protection film 76, and the dielectric layer 74 is polyester. Between the surface protection film 78 and the clear electrode layer 70 is an ink layer 80 patterned with selected transparent inks over selected regions of the clear electrode layer 70.

### Other Embodiments

A number of implementations have been described. Nevertheless, it will be understood that various modifications may be made without departing from the spirit and scope of the invention.

While implementations have been shown in which push-button switches are used to direct power to the phosphor material of the display, other types of switches are possible. For example, motion sensing, e.g., tilt sensing, light sensing, or pressure-sensing switches can be used. These switches can be used either alone or in conjunction with a master switch. For example, FIG. 5 shows an embodiment identical to that shown in FIG. 3, but with the omission of the master switch 23.

While implementations have been shown in which the display is mounted to a visible exterior surface of the shoe, e.g., a vamp of the shoe, other placements are possible. For example, the display can be mounted within a transparent or translucent sole such that the display is visible from behind the wearer.

While implementations have been shown in which each portion of the display uses the same phosphor material, e.g., white phosphor material, in some implementations, different portions of the display use different phosphor materials, e.g., for different colors or intensities in the display. Such a configuration enables attenuation of some portions relative to other portions.

Accordingly, other implementations are within the scope of the following claims:

1. A shoe comprising:
an electro-luminescent light-emitting display having a first portion and a second portion; and
a controller in electrical communication with the first and second portion of the display.

2. The shoe of claim 1, wherein the display is mounted to be visible from outside the shoe.

3. The shoe of claim 2, wherein the display is mounted to a location selected from a vamp, a quarter and a tongue.

4. The shoe of claim 1, wherein the controller is encased in a sole of the shoe.

5. The shoe of claim 1, wherein the display comprises:
a first non-conductive substrate;
a second non-conductive substrate; and
a patterned phosphor material sandwiched between the first and second non-conductive substrates, the phosphor material being in electrical communication with the controller.

6. The shoe of claim 5, wherein the controller is configured to direct power to illuminate selected portions of the patterned phosphor material.

7. The shoe of claim 6, wherein the selected portions are illuminated in a predetermined sequence.

8. The shoe of claim 6, wherein the selected portions are illuminated in a random sequence.

9. The shoe of claim 5, wherein the second non-conductive substrate comprises a light-transmissive colored film.

10. The shoe of claim 9, wherein a pattern defined by the light-transmissive film corresponds to a pattern defined by the patterned phosphor material.

11. The shoe of claim 1, wherein a thickness of the display is less than about 0.050 inches.

12. The shoe of claim 11, wherein the thickness of the display is less than about 0.025 inches.

13. The shoe of claim 12, wherein the thickness is less than about 0.015 inches.

14. The shoe of claim 5, wherein a thickness of the first non-conductive substrate is less than about 0.010 inches.

15. The shoe of claim 14, wherein the thickness of the first non-conductive substrate is less than about 0.005 inches.

16. The shoe of claim 5, wherein a thickness of the second non-conductive substrate is less than about 0.015 inches.

17. The shoe of claim 16, wherein the thickness of the second non-conductive substrate is less than about 0.010 inches.

18. The shoe of claim 5, wherein the first non-conductive substrate comprises polyester.

19. The shoe of claim 5, wherein the patterned phosphor material comprises an inorganic material.

20. The shoe of claim 19, wherein the inorganic material comprises zinc sulphide.

21. The shoe of claim 5, wherein a thickness of the patterned phosphor material is less than about 0.001 inches.

22. The shoe of claim 21, wherein the thickness of the patterned phosphor material is less than about 0.0005 inch.

23. The shoe of claim 1, further comprising a motion-sensitive switch in electrical communication with the controller.

24. The shoe of claim 1, further comprising a master switch disposed to disable illumination of the display.

25. A shoe comprising:
a light source;
a DC power source;
a DC/AC inverter disposed between the light source and the DC power source; and
a controller for selectively connecting an AC output to different portions of a display.

26. The shoe of claim 25, wherein the light source comprises an electro-luminescent display.

27. A shoe comprising an electro-luminescent display having individually addressable portions.
